(19) United States
(12) Patent Application Publication
(10) Pub. No.: US 2020/0128091 A1
(43) Pub. Date: Apr. 23, 2020

(54) SUBSCRIBING TO NOTIFICATIONS BASED ON CAPTURED IMAGE DATA

(71) Applicant: CA, Inc., New York, NY (US)

(72) Inventors: Serge Mankovskii, Morgan Hill, CA (US); Maria C. Velez-Rojas, Santa Clara, CA (US); Steven L. Greenspan, Philadelphia, PA (US)

(21) Appl. No.: 16/168,417

(22) Filed: Oct. 23, 2018

(51) Int. Cl. H04L 29/08; H04W 4/02; G06K 9/00; H04N 1/00

(52) U.S. Cl. CPC H04L 67/26; H04N 1/00095; G06K 9/00664; H04W 4/025

(57) ABSTRACT

A server computer system stores a plurality of display generation objects executable to cause display of display images. The server computer system receives a camera image from a user device. The server computer system determines that a particular display image included in the camera image corresponds to a particular display generation object. The server computer system then subscribes the user device to one or more data feeds selected based on the particular display generation object, and sends one or more notifications corresponding to the one or more selected data feeds to the user device.

### BACKGROUND

### Technical Field

This disclosure relates generally to sending notifications corresponding to information in data feeds to user devices.

### Description of the Related Art

Electronic displays, for example in public areas, are useable to display useful information to people who are nearby. In an airport, electronic displays are used to provide information about arrivals, departures, baggage claim, security checkpoints, etc. In shopping centers, electronic displays are used to provide information about the stores inside the shopping center, events that will be occurring at the shopping center, etc. Currently, a person near an electronic display can photograph the electronic display, and thereby capture the information currently displayed on the electronic display.

The content on such an electronic display can be provided in various ways such as by physical media that is accessed by a computer system coupled to the electronic display. Content can also be provided to an electronic display by a server.

### SUMMARY

In various embodiments, a user captures a camera image of a display image that was visible on a screen with a camera on a user device. The user device then sends this camera image to a server computer system. In some embodiments, the user annotates the camera image before it is sent. The server computer system stores a plurality of display generation objects, one of which was used to generate the display image that was shown on the screen, and receives the camera image from the user device. In various embodiments, the server computer system compares the camera image received from the use device to a plurality of stored display images (e.g., display images generated by the server computer system, display images generated by display computer systems and sent to the server computer system) to identify a display image that matches the camera image. Having identified the particular display image, the server computer system identifies the particular display generation object used to generate the particular display image, and selects one or more data feeds to which to subscribe the user device based on the particular display generation object (and the annotation information if any). The server computer system sends the user device one or more notifications corresponding to the selected data feeds.

### BRIEF DESCRIPTION OF THE DRAWINGS

FIG. 1 is a block diagram illustrating an embodiment of a computer system configured to subscribe a user device to notifications.

FIG. 2 is an expanded block diagram of the server computer system of FIG. 1 in accordance with various embodiments.

FIGS. 3A, 3B, 3C, and 4 show an example of a display image in accordance with various embodiments.

FIG. 5 is flowchart illustrating an embodiment of a data feed subscription method in accordance with the disclosed embodiments.

FIG. 6 is a block diagram of an exemplary computer system, which may implement the various components of FIGS. 1 and 2.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computer system configured to receive a camera image” is intended to cover, for example, a computer system has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, references to “first” and “second” display computer system would not imply an ordering between the two unless otherwise stated.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

As used herein, the word “module” refers to structure that stores or executes a set of operations. A module refers to hardware that implements the set of operations, or a memory storing the set of instructions such that, when executed by one or more processors of a computer system, cause the computer system to perform the set of operations. A module may thus include an application-specific integrated circuit implementing the instructions, a memory storing the instructions and one or more processors executing said instructions, or a combination of both.

### DETAILED DESCRIPTION

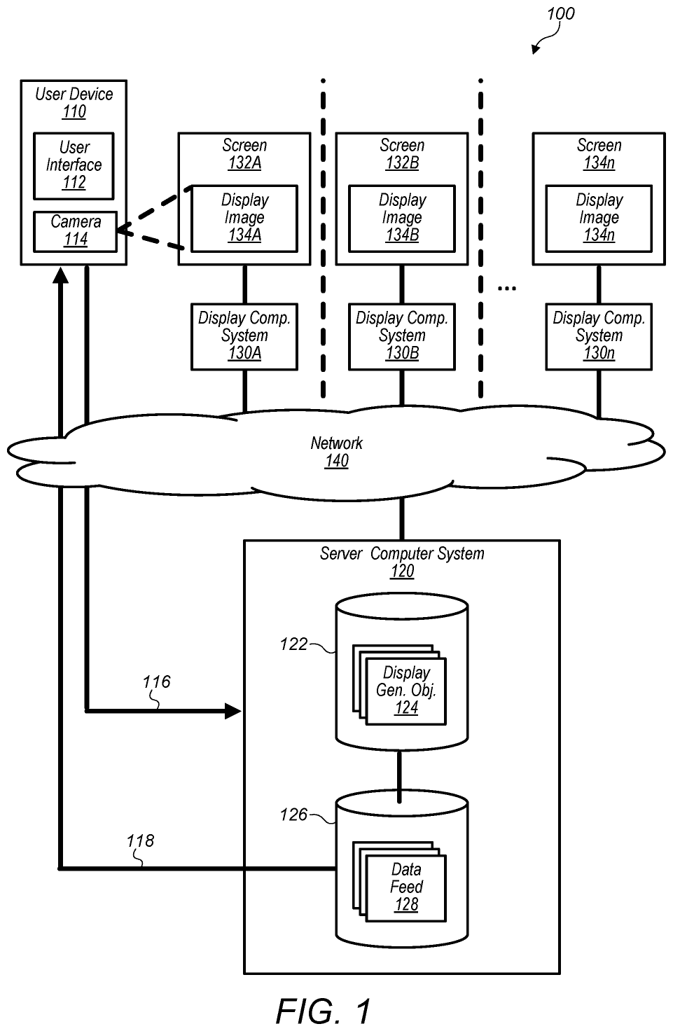

Referring now to FIG. 1, a block diagram of an exemplary embodiment of a computer system 100 is depicted. In various embodiments, computer system 100 includes a user device 110, a server computer system 120, and one or more display computer systems 130 with various components communicating over one or more networks 140.

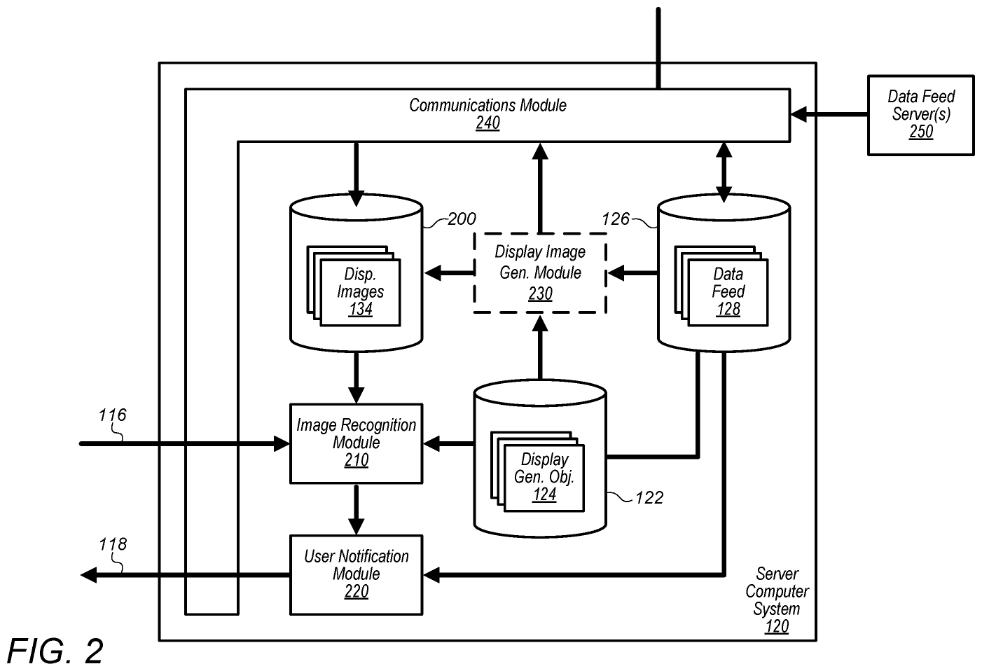

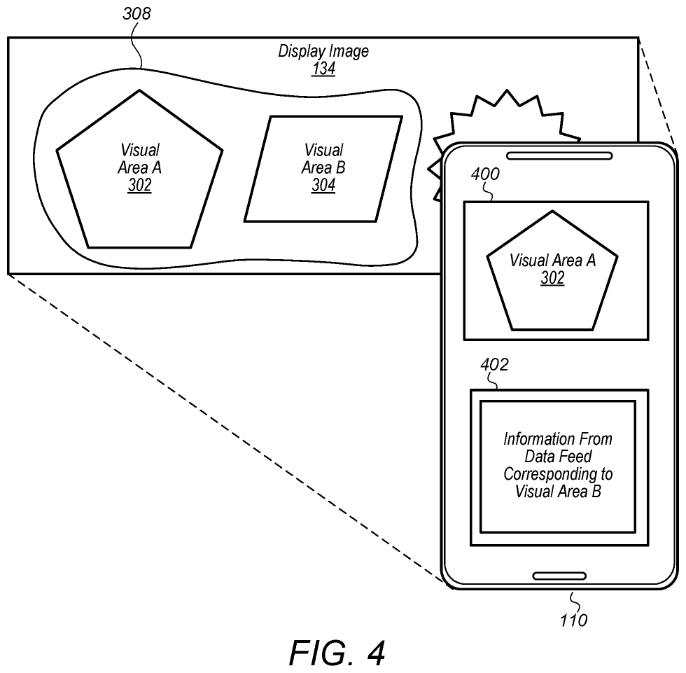

User device 110 is any of a number of computing devices including but not limited to a cellular phone, a smartphone, a tablet computer, or a laptop computer. In various embodiments, user device 110 includes user interface 112 and camera 114. In various embodiments, user device 110 is remote from server computer system 120 and the various display computer systems 130, although as discussed herein, in various instances user device 110 is physically proximate to one or more screens 132 such that camera 114 is useable to capture a camera image 116 that includes at least part of a particular display image 134A generated by a particular one of the plurality of display generation objects 124. In various embodiments, camera 114 is any of a number of devices useable to capture visual information in any of a number of formats and resolutions. In various embodiments, camera 114 includes one or more lenses, one or more optical sensors, and circuitry configured to take input from an optical sensor and produce camera image 116. In various embodiments, user interface 112 receives annotation information indicating a subportion of the camera image 116 (discussed in further detail in reference to FIG. 4 herein). In various embodiments, user interface 112 is configured to receive user input in any form. For example, user interface 112 is graphical user interface and touch-screen in some embodiments. In other embodiments, user interface 112 is a microphone and audio recording software. After capturing camera image 116, user device 110 is configured to send camera image 116 to server computer system 120 (e.g., via network 140). User device 110 is also configured to receive (e.g., from server computer system 120) one or more notifications 118 corresponding to one or more data feeds 128 as discussed herein. Notifications 118 are discussed in further detail in relation to FIGS. 2 and 4.

Server computer system 120 is one or more computer systems that communicate with user device 110 and various display computer systems 130 via network 140 as discussed herein. In various embodiments, server computer system 110 is remote from user device 110 and the display computer systems 130. Server computer system 120 may be implemented on a single computer system or a cloud of computer systems working in concert. As discussed in further detail in reference to FIG. 2, in various embodiments, server computer system 120 includes a storage 122 storing a plurality of display generation objects 124 and a storage 126 storing information from a plurality of data feeds 128. In various embodiments, storage 122 and storage 126 are implemented separately (e.g., on separate storage systems, on the same storage system but logically separated) or may be implemented together with the same storage system using any type of storage medium (e.g., one or more hard drives, solid state storage). Display generation objects 124 are computer code that is executable to cause display of respective display images 134 at different respective remote locations (e.g., first display image 134A on screen 132A, second display image 134B on screen 132B, etc.). In various embodiments, data feeds 128 include any type of information that may be included in a display image 134. Display generation objects 124 and data feeds 128 are discussed in further detail herein in reference to FIG. 2.

As discussed in further detail herein, server computer system 120 is configured to receive camera image 116, which includes at least part of a particular display image 134 generated by a particular one of the plurality of display generation objects 124. In various embodiments, server computer system 120 is configured to receive annotation information indicating a subportion of the camera image 116. In various embodiments, such annotation information is sent with camera image 116 (e.g., by being drawn on top of an image captured by camera 114 of user device 110) or is sent separately from camera image 116 (e.g., in one or more files sent from user device 110 to server computer system 120.). In various embodiments, server computer system 120 is configured to determine that the particular display image 134 included in camera image 116 corresponds to a particular display generation object 124 (e.g., the particular display generation object 124 that was executed to generate the particular display image 134). In various embodiments, server computer system 120 is configured to subscribe user device 110 to one or more data feeds 128. In various embodiments, the data feeds 128 are selected based on the particular display generation object 124 (i.e., the display generation object corresponding to the display image 134 included in camera image 116). In some of such embodiments, this selection is also based on the subportion of camera image 116 indicated by the annotation information. In various embodiments, server computer system 120 is configured to send one or more notifications 118 corresponding to the one or more selected data feeds 124 to user device 110.

The one or more display computer systems 130 are computer systems that communicate with server computer system 120 via network 140 as discussed herein. In various embodiments, there are a plurality of display computer systems 130, shown in FIG. 1 as first display computer system 130A, second display computer system 130B, and nth display computer system 130n. Each of the various display computer systems 130 are in different locations (shown in FIG. 1 by the dashed vertical lines) that are remote from server computer system 120. The various display computer systems 130 are coupled to various screens 132 (e.g., first screen 132A, second screen 132B, and nth screen 132n) which are configured to show the various display images 134 as discussed herein. In various embodiments, a particular screen 132 may be any of a number of electronic displays including but not limited to LCD displays, LED displays, OLED displays, CRT displays, projection displays, etc. in any size, resolution, or configuration. In various embodiments, a display computer system 130 may be coupled to a plurality of screens 132, and may be configured to display the same display image 134 on each, or different display images 134 on each. For example, a display computer system 130 in an airport may control the various screens 132 installed at the ticketing area of the airport showing the various departures using display images 134 as discussed herein. Display images 134 are discussed in further detail in reference to FIGS. 2, 3A, 3B, 3C, and 4 herein.

In various embodiments, network 140 includes one or more computer networks and allows the various components of computer system 100 to communicate with one another. In various embodiments, network 140 includes any number of wired and/or wireless transmission mediums. In various embodiments, network 140 includes the Internet. As discussed herein, in various embodiments, user device 110 sends camera image 116 to server computer system 120 and receives notification(s) 118 from server computer system 120 via network 140. Moreover, server computer system 120 and the various display computer systems 130 are able to communicate via network 140, and in various embodiments send messages including display generation objects 124, information from data feeds 128, and/or display images 134 as discussed herein.

In various embodiments, computer system 100 is operable to enable a user to utilize their user device 110 to capture a camera image 116 of a display 132 and get their user device 110 subscribed to data feeds 128. The subscribed user device 110 can then receive notifications 118 corresponding to information on the display 132. As an example, using the techniques discussed herein, a user in an airport is able to capture a camera image 116 of a screen 132 in the departures area of the airport and receive notifications 118 corresponding to plane departures (e.g., flight delays, gate changes). In another example, a user is able to capture a camera image 116 of a screen 132 in a shopping center and receive notifications 118 about the shopping center (e.g., a map of the shopping center, a directory of stores) and/or notifications 118 about goings-on outside of the shopping center (e.g., a trailer for a movie advertised on screen 132, a link to a website advertised on screen 132).

Referring now to FIG. 2, an expanded block diagram of server computer system 120 of FIG. 1 is depicted in accordance with various embodiments. As shown in FIG. 1, server computer system 120 includes storage 122, a plurality of display generation objections 124, storage 126, and information from a plurality of data feeds 128. As shown in FIG. 2, in various embodiments, server computer system 120 includes storage 200, an image recognition module 210, a user notification module 220, a display image generation module 240, and a communications module 240. It will be understood, however, that in various embodiments one or more of the components depicted in FIG. 2 are not present. For example, in some embodiments, server computer system 120 does not generate display images 134 (and instead receives them from display computer system 130) and in such embodiments, display image generation module 240 is not present.

As discussed in reference to FIG. 1, storage 120 stores a plurality of display generation objects 124. In various embodiments, display generation objects 124 are computer code that is executable to cause display of respective display images 134 at different respective remote locations (e.g., first display image 134A on screen 132A, second display image 134B on screen 132B, etc.). In various embodiments, display generation objects 124 include one or more pointers, wherein each pointer corresponds to a respective data feed 128, and a schema useable to generate the respective display image 134 corresponding to the display generation object 124 using one or more data feeds 128. Thus, in such embodiments, display generation objects 124 are executable by a computer system (e.g., either or both of server computer system 120 or display computer system 130) to assemble information from (or based on) one or more data feeds 128 into any of a number of ways to create respective display images 134 for display on one or more screens 132.

For example, in some embodiments where a screen 132 is located in the ticketing area of an airport, the particular display image 134 for that particular screen 132 includes information about the departures of various planes. In such an instance, the display generation object 124 includes pointers to one or more data feeds 128 that provide the information about the various planes (e.g., carrier, flight number, scheduled departure time), one or more data feeds about conditions at the airport (e.g., estimated departure time of delayed planes, gate information for the planes), and a schema to arrange the information (e.g., with a heading reading “Departures” and rows of information for each plane). In another example, in embodiments where a particular screen 132 is located in a shopping center, the particular display image 134 includes advertisements for retailers in the shopping center and entertainment feeds for customers (e.g., a sports ticker, a trailer for a movie). In such an example, the display generation object 124 includes pointers to the various data feeds 128 (e.g., a mall advertisement data feed 128, a sports data feed 128, and a movie trailer data feed 128) and a schema to control where information from the data feeds will be displayed in display image 134.

In some embodiments discussed herein, server computer system 120 uses the display generation objects 124 to generate the respective display images 134 (e.g., with display image generator module 230) and sends them to their respective display computer systems 130 for display. In other embodiments, server computer system 120 sends one or more particular display generation objects 124 to one or more particular remote display computer systems 130, and these display generation objects 124 are useable by the remote display computer system 130 to cause the particular display image 134 to be displayed on one or more particular screens 132. In some of such embodiments, one or more of the display computer system 130 receive information from one or more data feeds 128 directly. In some of such embodiments, the display generation objects 124 may be modified using the display computer system 130 to, for example, add additional information (e.g., advertising, additional data feeds 128) or to reorganize the schema.

As discussed in reference to FIG. 1, storage 126 stores information from a plurality of data feeds 128. In various embodiments, for example, the various data feeds 128 include information indicative of (but not limited to) weather, transportation status (e.g., arrival and departure information), financial information (e.g., stock ticker information), entertainment information (e.g., movies, television shows, sports), customer service information (e.g., place in a numerical waitlist for counter service, place in a waitlist for a seat in a dining room), and gambling information (e.g., a keno board). The source(s) of the various data feeds 128 are indicated by one or more indicators stored on server computer system 120. In some instances, the source of one or more data feeds 128 are server computer system 120. In some instances, the source of one or more data feeds are the one or more display computer systems 130. In some instances, the source of one or more data feeds 128 is a data feed server 250 such as a weather service server that communicates with server computer system 120 (e.g., over the Internet).

In various embodiments, server computer system 120 includes storage 200. In various embodiments, storage 200, storage 122 and/or storage 126 are implemented separately (e.g., on separate storage systems, on the same storage system but logically separated) or may be implemented together with the same storage system using any type of storage medium (e.g., one or more hard drives, solid state storage). In various embodiments, server computer system 120 stores one or more display images 134 in storage 200. In some embodiments, one or more of the display images 134 in storage 200 had been generated by a display computer system 130 and received by server computer system 120 (e.g., via network 140). In some embodiments, one or more of the display images 134 in storage 200 had been generated by server computer system 120 using display image generation module 230.

In various embodiments, server computer system 120 includes display image generation module 230. In such embodiments, display image generation module 230 is configured to generate respective display image files 134 corresponding to ones of the plurality of display generation objects 124. In various embodiments, display image generation module 230 accesses information from one or more data feeds 128 as indicated by a particular display generation object 124 and assembles such information into the corresponding particular display image 134 using the schema included in the particular display generation object 124. In various embodiments, server computer system 120 sends these generated display image files 134 to various display computer systems 130 for display on respective screens 132. In various embodiments, server computer system 120 uses display image generation module 230 to regularly generate display images 134 periodically or when updated information is received from data feeds 128. In such embodiments, server computer system 120 uses display image generation module 230 to generate revised display images 134 that reflect more up-to-date information from data feeds 128. In embodiments where server computer system 120 generates the display images 134 for display computer systems 130, these revised display images 134 are in turn sent to their respective display computer systems 130.

Image recognition module 210 is configured to determine that a particular display image 134 included in the camera image 116 corresponds to a particular display generation object 124. In some embodiments, determining that the particular display image included in the camera image corresponds to the particular display generation object includes comparing camera image 116 to one or more display images 134 (e.g., copies generated by server computer system 120, copies generated by a display computer system 130 and send to server computer system 120) in storage 200 to find a match. As used herein, a “match” includes an identical match where camera image 116 is identical to a particular display image 134 and an approximate match in which camera image 116 is sufficiently similar (e.g., above a positive match threshold) to a particular display image 134 when compared. In some embodiments, image recognition module 120 uses “fuzzy matching” techniques that determine which portions of camera image 116 match one or more display images 134 (e.g., the portion of camera image 116 that shows a display image 134) and determines which portions of camera image 116 do not match (e.g., the area around screen 132, obstructions in front of screen 132 or glare on screen 132, portions of display image 134 that have been changed locally such as locally-inserted advertisements). In such embodiments, image recognition module 120 is configured to identify the display image 134 having the highest approximate match score or match percentage for camera image 116. If the match score/percentage is above a threshold value (e.g., 85% match although any other threshold can be used), image recognition module 210 determines that the picture of screen 132 in camera image 116 matches a particular display image 134 and the image recognition module 210 identifies the particular display generation object 124 that was used to generate that particular display image 134. In some embodiments, if the match score/percentage is below the threshold value for a positive match, but above a lower threshold (e.g., 50% match although any other threshold can be used), server computer system 120 is configured to send a message to user device 110 with one or more candidate display images 134 and receive a selection by the user of the display images 134 user captured an image of in the camera image 116.

In some embodiments, in addition to comparing the visual information of camera image 116 to a plurality of display images 134, image recognition module 210 is configured to determine that the particular display image 134 included in camera image 116 corresponds to the particular display generation object 124 based on metadata associated with camera image 116. In some embodiments, image recognition module 210 is configured to use a time and date at which the camera image 116 was captured included in metadata to match camera image 116 to a display image 134 (e.g., by matching camera image 116 with a particular display image 134 that was being displayed on a screen 132 approximately when the camera image 116 was captured). In some embodiments, image recognition module 210 is configured to use a location at which camera image 116 was captured included in the metadata to match camera image 116 to a display image 134 (e.g., by matching camera image 116 with a particular display image 134 that was being displayed on a screen 132 nearby the location where camera image 116 was captured).

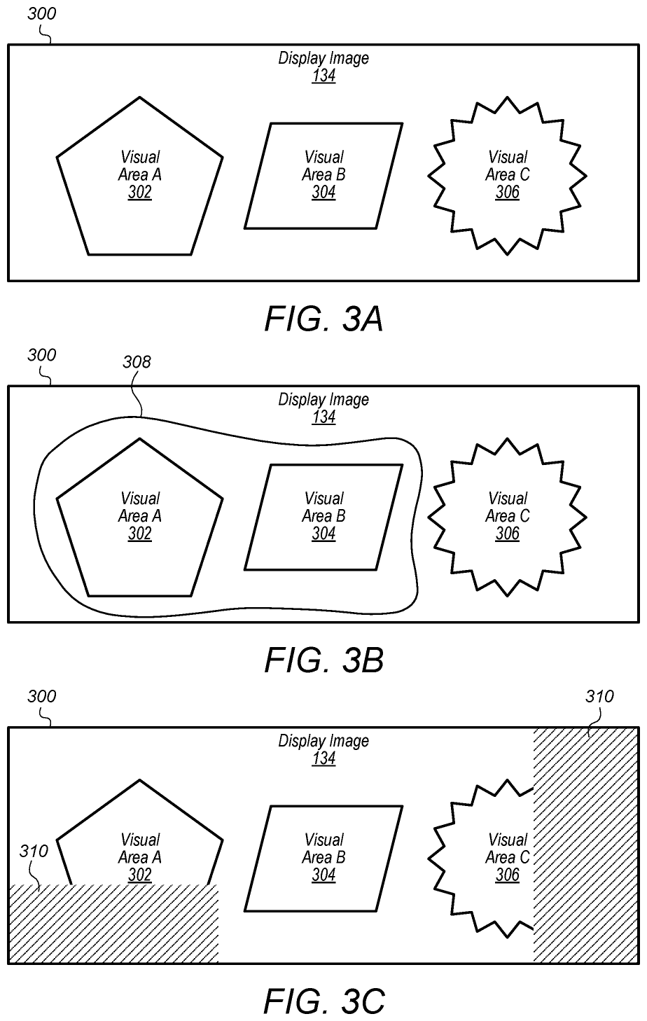

User notification module 220 subscribes the remote user device 110 to one or more selected data feeds 128 and sends notifications to the user device 110 corresponding to the selected data feeds 128. In various embodiments, the data feeds 128 are selected based on the particular display generation object 124 (e.g., determined by image recognition module 210) and, in some embodiments, annotation information (e.g., the annotation information 308 discussed in reference to FIG. 3). In some embodiments, user notification module 220 is configured to send, to user device 110, an indication of one of more data feeds 128 that have been selected based on the particular display generation object 124 (e.g., determined by image recognition module 210). In such embodiments, user notification module 220 is configured to receive, from user device 110, a subscription confirmation indicative of one or more selected data feeds 128 (e.g., a message in which the user of user device 110 has identified one or more of the selected data feeds 128 for which user has elected to receive notifications). In such embodiments, notifications 118 include notifications only from the data feeds identified in the subscription confirmation message.

In various embodiments, notifications 118 are any of a number of electronic messages sent from server computer system 120 to user device 110. For example, notifications 118 include but are not limited to push notification sent to an application installed on user device 110, SMS or MMS messages sent to user device 110, emails sent to an email account associated with a user of user device 110, etc. In some embodiments, separate notifications 118 are sent for each selected data feed 128, but in other embodiments a notification 118 may include information from a plurality of selected data feeds 128. In various embodiments, notifications 118 include: (i) information from the one or more selected data feeds 128 that was being displayed at the time camera image 116 was captured (for example, flight departure information as shown on a screen 132 in the departures area of an airport), (ii) information from the one or more selected data feeds 128 displayed after the time camera image 116 was captured (for example, updated flight departure information that was shown on the same screen 132 after user captured camera image 116), or both (i) and (ii). In some embodiments, notifications include information from the one or more selected data feeds 128 that is related to information that was displayed but is not itself displayed. In such embodiments, such information might include (but is not limited to) information presented at a higher level of detail (e.g., notification 118 includes a play-by-play for a sporting event whereas display image 134 included only the score of the sporting event), information presented in a different format (e.g., notification 118 includes a video of a movie trailer whereas display image 134 included only the movie's poster; notification 118 includes an audio version of text appearing on display image 134), information translated into a different language (e.g., notification 118 includes English whereas the display image 134 includes Japanese but not English).

In various embodiments, user notification module 220 is configured to send notifications 118 for a limited amount of time. This amount of time may be limited, for example, by a period of time set by a user of user device 110 (e.g., in a profile associated with the user in which the user has indicated that he or she wants to receive notifications 118 for two hours after camera image 116 is captured). In various embodiments where notifications 118 are sent for a predefined period of time, the start of such a predefined period of time may be defined by metadata associated with the camera image that indicates a time and date at which the camera image was captured. In such embodiments, user notification module 220 determines, based on the metadata, the time and date at which camera image 116 was captured, sends notifications 118 for a predefined period of time (e.g., two hours, although any time period may be used) after the time and data at which camera image 116 was captured, and ceasing to send notifications 118 after the predefined period of time. In various embodiments, notifications 118 may be halted based on receiving a command from user device 110 to cease sending notifications 118.

In various embodiments, server computer system 120 includes one or more communications modules 240 configured to send and receive messages from other computer systems such as user device 110, display computer system 130, and/or data feed server 250. Various communications modules 240 are configured to communicate via network 140 (e.g., over the Internet, over a closed network, over a cellular network).

Referring now to FIGS. 3A, 3B, 3C, and 4, an example 300 of display image 134 is shown. In each of FIGS. 3A, 3B, 3C, and 4, example 300 includes a visual area A 302, a visual area B 304, and a visual area C 306. In various embodiments, the various visual areas 302, 304, 306 each correspond to one or more data feeds 128. In some embodiments, information from a particular data feed 128 is presented in only one of the visual areas 302, 304, 306 but in other embodiments, information from a particular data feed 128 is presented in more than one visual area. For example, if example 300 is a display image 134 shown on a screen 132 in the departures area of an airport, visual area A 302 may include information from a first data feed 128 about the various planes that will be departing during a period of time, visual area B 304 may include information from a second data feed 128 about the status of the planes (e.g., on-time, delayed, etc.), and visual area C 304 may include information about dining options in the airport (e.g., restaurant X is near Gate 20, restaurant Y is near Gate 30). FIG. 3A depicts example 300 as it was originally generated (e.g., by server computer system 120, by display computer system 130).

Referring now to FIG. 3B, a camera image 116 of example 300 as shown in FIG. 3A is depicted with annotation information 308 shown. In various embodiments, annotation information 308 indicates one or more subportions of the particular display image 134. For example, annotation information 308 encircles visual area A 302 and visual area B 304, but not visual area C 306. In various embodiments, annotation information 308 includes one of more visual annotations drawn on the camera image 116 (e.g., by a user of user device 110 using a touch-screen use interface 112 to draw a line encircling a portion of camera image 116). In various other embodiments, annotation information 408 includes audio information spoken by a user of the remote use device 110 that indicates one or more visual areas (e.g., visual areas 302, 304, 306). As discussed herein, annotation information (e.g., annotation information 308 shown in FIG. 3B) is used to determine to which data feeds 128 to subscribe user device 110. For example, in FIG. 3B, annotation information 308 indicates visual area A 302 and visual area B 304, and in such an example, user device 120 would be subscribed to data feeds 128 associated with visual area A 302 and visual area B 304 but not with data feeds 128 that are only associated with visual area C 306. In addition to being received via a graphical user interface 112 or an audio user interface 112, annotation information 308 may be received from the user via any of a number of user interfaces 112 (e.g., a haptic user interface 112, a user interface 112 that interacts with a peripheral device such as a camera to receive user input, etc.).

Referring now to FIG. 3C, a camera image 116 captured of example 300 includes one or more obstructions 310 (e.g., objects in front of screen 132, damage to or glare on screen 132) that block certain portions of example 300. As discussed herein, because image recognition module 210 uses approximate matching to determine that a particular camera image 116 includes a particular display image 134, such obstructions 310 do not necessarily inhibit the ability of image recognition module 210 to identify a close enough match.

Referring now to FIG. 4, example 300 as shown in FIG. 3B is depicted with a user device 110 having captured a camera image 116 of example 300 and user device 110 receiving various notifications 118 as discussed herein. As discussed in connection to FIG. 3B, annotation information 308 indicates visual area A 302 and visual area B 304. After the camera image 116 of example 300 with annotation information 308 is sent to server computer system 120, user device 110 is subscribed to selected data feeds 128 associated with visual area A 302 and visual area B 304. Notification 400 shows a representation of visual area A 302 on user device 110 (e.g., a representation of flight departure information as it appears in visual area A 302 on screen 132 in the departure area of the airport). Notification 402 shows a representation of information from one or more data feeds 128 corresponding to visual area B 304 but does not show visual area B 304 as it was captured in camera image 116. As discussed herein, notification 402 may depict information from the various data feeds 128 showing revised information that was not depicted in visual area B 304 when camera image 116 was captured in some embodiments, or may depicted additional information related to information that was depicted in visual area B 304 but was not itself depicted (e.g., information at a greater level of detail). For example, notification 400 might show flight information for various planes departing during a period of time, and notification 402 might show additional information about the reason a particular flight has been delayed.

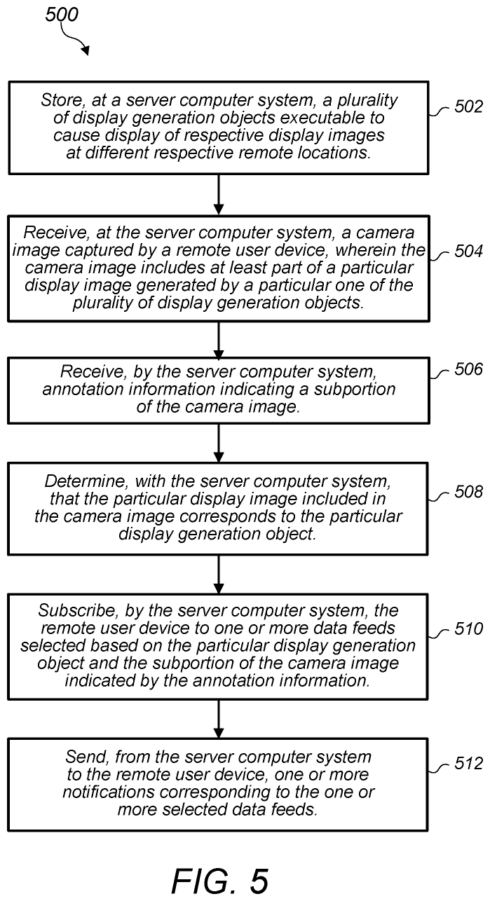

Referring now to FIG. 5, a flowchart illustrating an embodiment of a data feed subscription method 500 is shown. In various embodiments, the various actions associated with method 500 are performed with server computer system 120. At block 502, server computer system 120 stores a plurality of display generation objects 124 executable to cause display of respective display images 134 at different respective remote locations (e.g., on screens 132). At block 504, server computer system 120 receives a camera image 116 captured by a remote user device 110, wherein the camera image 116 includes at least part of a particular display image 134 generated by a particular one of the plurality of display generation objects 124. At block 506, server computer system 120 receives annotation information (e.g., annotation information 308) indicating a subportion of the camera image 116. At block 508, server computer system 120 determines that the particular display image 134 included in the camera image 116 corresponds to the particular display generation object 124. At block 510, server computer system 120 subscribes the remote user device 110 to one or more data feeds 128 selected based on the particular display generation object 124 and the subportion of the camera image 116 indicated by the annotation information. At block 512, server computer system 120 sends one or more notifications 118 corresponding to the one or more selected data feeds 128 to the remote user device 110.

Using the techniques discussed herein, a user is able to capture a camera image 116 of a screen 132, send the camera image 116 to a server computer system 120, and become subscribed to notifications 118 related to information that is visible on screen 132. For example, a user in the departure area of an airport is able to capture a camera image 116 of a screen 132 in the departure area and annotate the image 116 to indicate about which visual area(s) the user would like to receive notifications 118. The user's user device 110 then sends the camera image 116 (and any annotation information) to server computer system 120. Server computer system 120 receives the camera image 116 and annotation information, determines which particular display image 134 was visible on screen 132 when the camera image 116 was captured, determines which display generation object 124 was used to generate the display image 134 shown on the screen in the departures area, and subscribes the user device 110 to one or more data feeds 128 corresponding to the display generation object 124 (and as indicated by the annotation information). The server computer system 120 then sends the user notifications 118 corresponding to these selected data feeds 128 (e.g., notification 118 relating to planes that are departing that day).

Moreover, using the techniques disclosed herein, a user is able to capture a camera image 116 of an image on a screen 132 or even not on a screen (e.g., on a poster) and receive notifications 118 corresponding to the image in various embodiments. In some of such embodiments, the user is able to annotate camera image 116 to indicate a subportion of the image. In such embodiments, the image was not generated using a display generation object 124, but server computer system 120 is configured to identify the image (e.g., with an image matching library, with a neural network) and send notifications 118 to user device 110 including additional information about what is depicted in the image. For example, in some embodiments, the user captures a camera image 116 of a map and circles Jamaica on the camera image 116. This camera image 116 and annotation information is sent to server computer system 120, which determines that camera image 116 depicts a map in which Jamaica has been circled. After identifying Jamaica in the camera image 116, server computer system 120 accesses one or more data feeds 128 relating to Jamaica (e.g., a first data feed 128 of weather in Jamaica, a second data feed 128 of foreign exchange rates for Jamaican dollars, etc.) and sends one or more notifications 118 to user device 110 corresponding to information from these data feeds 128.

### Exemplary Computer System

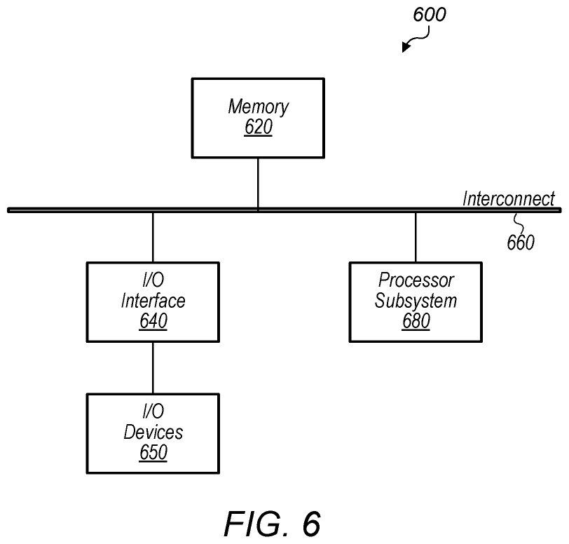

Turning now to FIG. 6, a block diagram of an exemplary computer system 600, which may implement the various components of computer system 100 (e.g., user device 110, server computer system 120, display computer systems 130) is depicted. Computer system 600 includes a processor subsystem 660 that is coupled to a system memory 620 and I/O interfaces(s) 640 via an interconnect 660 (e.g., a system bus). I/O interface(s) 640 is coupled to one or more I/O devices 650. Computer system 600 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 600 is shown in FIG. 6 for convenience, system 600 may also be implemented as two or more computer systems operating together.

Processor subsystem 660 may include one or more processors or processing units. In various embodiments of computer system 600, multiple instances of processor subsystem 660 may be coupled to interconnect 660. In various embodiments, processor subsystem 660 (or each processor unit within 660) may contain a cache or other form of on-board memory.

System memory 620 is usable to store program instructions executable by processor subsystem 660 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 660 and secondary storage on I/O Devices 650 (e.g., a hard drive, storage array, etc.). In some embodiments, these other forms of storage may also store program instructions executable by processor subsystem 660.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
storing, at a server computer system, a plurality of display generation objects executable to cause display of respective display images at different respective remote locations;
receiving, at the server computer system, a camera image captured by a remote user device, wherein the camera image includes at least part of a particular display image generated by a particular one of the plurality of display generation objects;
receiving, by the server computer system, annotation information indicating a subportion of the camera image;
determining, with the server computer system, that the particular display image included in the camera image corresponds to the particular display generation object;
subscribing, by the server computer system, the remote user device to one or more data feeds selected based on the particular display generation object and the subportion of the camera image indicated by the annotation information; and
sending, from the server computer system to the remote user device, one or more notifications corresponding to the one or more selected data feeds.

2. The method of claim 1, wherein each display generation object includes:
one or more pointers, wherein each pointer corresponds to a respective data feed, and
a schema useable to generate the respective display image corresponding to the display generation object using one or more data feeds.

3. The method of claim 1, wherein the one or more notifications include:
(i) information from the one or more selected data feeds that was being displayed at the time the camera image was captured,
(ii) information from the one or more selected data feeds displayed after the time the camera image was captured, or
both (i) and (ii).

4. The method of claim 1, wherein the one or more notifications include from the one or more selected data feeds, that is related to information that was displayed but is not itself displayed.

5. The method of claim 1,
wherein the particular display image includes a first visual area corresponding to a first data feed and a second visual area corresponding to a second data feed;
wherein the subportion indicated by the annotation information includes the first visual area but not the second visual area; and
wherein the subscribing includes subscribing the remote user device to the first data feed but not the second data feed.

6. The method of claim 1, wherein the annotation information includes one of more visual annotations drawn on the camera image.

7. The method of claim 1, further comprising:
sending, from the server computer system to a particular remote display computer system coupled to a particular screen, a particular display generation object useable by the particular remote display computer system to cause the particular display image to be displayed on the particular screen.

8. The method of claim 1 further comprising:
generating, with the server computer system using the plurality of display generation objects, server copies of respective display image files corresponding to ones of the plurality of display generation objects;
wherein determining that the particular display image included in the camera image corresponds to the particular display generation object includes:
comparing the camera image to one or more of the server copies of respective display image files,
determining that the camera image corresponds to a particular server copy of a display image file, and
identifying the display generation object used to generate the particular server copy of a display image file as the display generation object that corresponds to the particular display image included in the camera image.

9. The method of claim 1 further comprising:
receiving, at the server computer system from one or more display computer systems, one or more display image files generated by the display computer system using ones of the plurality of display generation objects;
wherein determining that the particular display image included in the camera image corresponds to the particular display generation object includes:
comparing the camera image to the one or more received display image files,
determining that the camera image corresponds to a particular received display image file, and
identifying the display generation object used to generate the particular received display image file as the display generation object that corresponds to the particular display image included in the camera image.

10. The method of claim 1, wherein the camera image includes visual information and metadata, the method further comprising:
determining, by the server computer system based on the metadata, a time and date at which the camera image was captured;
wherein sending the one or more notifications corresponding to the one or more data feeds corresponding to particular display image includes:
sending one of more notifications for a predefined period of time after the time and data at which the camera image was captured, and
ceasing to send notifications after the predefined period of time.

11. A non-transitory, computer-readable medium storing instructions that when executed by a server computer system cause the server computer system to perform operations comprising:
storing, at the server computer system, a plurality of display generation objects executable to cause display of respective display images at different respective remote locations;
receiving, at the server computer system, a camera image captured by a remote user device, wherein the camera image includes at least part of a particular display image generated by a particular one of the plurality of display generation objects;
receiving, by the server computer system, annotation information indicating a subportion of the camera image;
determining, with the server computer system, that the particular display image included in the camera image corresponds to the particular display generation object;
subscribing, by the server computer system, the remote user device to one or more data feeds selected based on the particular display generation object and the subportion of the camera image indicated by the annotation information; and
sending, from the server computer system to the remote user device, one or more notifications corresponding to the one or more selected data feeds.

12. The computer-readable medium of claim 11,
wherein the camera image includes visual information and metadata, and
wherein determining that the particular display image included in the camera image corresponds to the particular display generation object is based on the (i) visual information (ii) a time and date at which the camera image was captured included in the metadata, (iii) a location at which the camera image was captured included in the metadata, or any combination of (i), (ii), and (iii).

13. The computer-readable medium of claim 11, further comprising
generating, with the server computer system using the plurality of display generation objects, respective display image files corresponding to ones of the plurality of display generation objects; and
sending, from the server computer system to one or more display computer systems, the display image files;
wherein determining that the particular display image included in the camera image corresponds to the particular display generation object includes:
comparing the camera image to the respective display image files,
determining that the camera image corresponds to a particular display image file, and
identifying the display generation object used to generate the particular display image file as the display generation object that corresponds to the particular display image included in the camera image.

14. The computer-readable medium of claim 11, further comprising:
generating, with the server computer system using the plurality of display generation objects, respective, first display image files corresponding to ones of the plurality of display generation objects;
sending, from the server computer system to one or more display computer systems, the first display image files;
receiving, at the server computer system, updates to one or more data feeds;
generating, with the server computer system using the plurality of display generation objects and the received updates, respective, second display image files corresponding to ones of the plurality of display generation objects; and
sending, from the server computer system to one or more display computer systems, the second display image files.

15. The computer-readable medium of claim 11, wherein annotation information includes audio information spoken by a user of the remote use device.

16. The computer-readable medium of claim 11, the operations further comprising:
receiving, at the server computer system from the remote user device, a command to cease sending notifications; and
based on the command, ceasing the sending of notifications to the remote user device.

17. The computer-readable medium of claim 11, wherein the one or more notifications include information from the one or more selected data feeds translated from a visual form into an audio form.

18. The computer-readable medium of claim 11, wherein information included in the particular display image is in a first language and the notifications are in a second language.

19. A server computer system comprising:
a computer processor system; and
a computer memory storing instructions that when executed by the computer processor system causes the server computer system to perform operations comprising:
storing, at the server computer system, a plurality of display generation objects executable to cause display of respective display images at different respective remote locations;
receiving, at the server computer system, a camera image captured by a remote user device, wherein the camera image includes at least part of a particular display image generated by a particular one of the plurality of display generation objects;
determining, with the server computer system, that the particular display image included in the camera image corresponds to the particular display generation object;
subscribing, by the server computer system, the remote user device to one or more data feeds selected based on the particular display generation object; and
sending, from the server computer system to the remote user device, one or more notifications corresponding to the one or more selected data feeds.

20. The server computer system of claim 19, the operations further comprising:
sending, from the server computer system to the remote user device, an indication of the one or more selected data feeds; and
receiving, at the server computer system and from the remote user device, a subscription confirmation indicative of one or more selected data feeds;
wherein the one or more notifications includes only the selected data feeds indicated by the subscription confirmation.
